(19) United States
(12) Patent Application Publication
(10) Pub. No.: US 2026/0084492 A1
(43) Pub. Date: Mar. 26, 2026

(54) CE MODULE AND VEHICLE INCLUDING THE SAME

(71) Applicants: Hyundai Motor Company, Seoul (KR); Kia Corporation, Seoul (KR)

(72) Inventors: Jeawan KIM, Hwaseong-Si (KR); Hochan AN, Hwaseong-Si (KR); Yeonho KIM, Hwaseong-Si (KR); Hoyoung JEONG, Hwaseong-Si (KR); Man Hee PARK, Hwaseong-Si (KR); Yeong Jun KIM, Hwaseong-Si (KR); Jae Yeon KIM, Hwaseong-Si (KR); Gwi Taek KIM, Hwaseong-Si (KR)

(73) Assignees: Hyundai Motor Company, Seoul (KR); Kia Corporation, Seoul (KR)

(21) Appl. No.: 18/970,536

(22) Filed: Dec. 5, 2024

(30) Foreign Application Priority Data
Sep. 24, 2024 (KR) 10-2024-0129169

(51) Int. Cl. B60H 1/32

(52) U.S. Cl. CPC B60H 1/3225; B60H 1/32284; B60H 1/3229

(57) ABSTRACT

A centralized energy (CE) module includes: a compressor mounted on a base plate of the CE module and compressing a refrigerant; a condenser mounted on the base plate to be spaced apart from the compressor, and condensing the compressed refrigerant supplied from the compressor connected to the condenser; a receiver dryer connected to the condenser and storing the liquid refrigerant; an evaporator mounted on the base plate to be spaced apart from the condenser, and evaporating the refrigerant supplied from an expansion valve connected to the evaporator and the compressor; a cover housing mounted on the base plate to accommodate the compressor, the condenser, the receiver dryer, the expansion valve, and the evaporator in the cover housing; and a fire extinguisher disposed on an outside of the cover housing, and including a fire extinguishing tank storing an extinguishing powder, a fire extinguishing passage connecting the fire extinguishing tank with an interior of the cover housing, and a fire extinguishing valve selectively opening the fire extinguishing passage.

### CROSS-REFERENCE TO RELATED APPLICATION

The present application claims priority to Korean Patent Application No. 10-2024-0129169 filed on Sep. 24, 2024, the entire contents of which is incorporated herein for all purposes by this reference.

### BACKGROUND OF THE PRESENT DISCLOSURE

### Field of the Present Disclosure

The present disclosure relates to a centralized energy (CE) module and a vehicle including the same, and more particularly, to a CE module provided with a fire extinguisher to safely use an eco-friendly refrigerant having high flammability and high explosive property, and a vehicle including the same.

### Description of Related Art

In general, an air conditioning system for a vehicle may have an air conditioning system that circulates a refrigerant to heat or cool a vehicle interior.

The air conditioning system may be configured to maintain a temperature of the vehicle interior at an appropriate temperature regardless of an external temperature change, to maintain a comfortable indoor environment, and to cool the vehicle interior by heat-exchange through an evaporator in a process in which the refrigerant discharged by operation of a compressor is circulated back to the compressor through a condenser, a receiver dryer, an expansion valve, and the evaporator.

That is, in a cooling mode during summer, the air conditioning system may lower the internal temperature and humidity through the process in which the high-temperature and high-pressure gaseous refrigerant compressed by the compressor is condensed by the condenser, passes through the receiver dryer and the expansion valve, and is then evaporated in the evaporator.

Meanwhile, there is a demand to develop an eco-friendly vehicle capable of practically replacing an internal combustion engine vehicle due to recently growing interest in energy efficiency and environmental pollution issues, and the eco-friendly vehicle is usually categorized into an electric vehicle powered by a fuel cell or electricity or a hybrid vehicle powered by an engine and a battery.

Among the eco-friendly vehicles, the electric vehicle or the hybrid vehicle does not use a separate heater, unlike the air conditioning system of a general vehicle, and the air conditioning system applied to the eco-friendly vehicle is usually referred to as a heat pump system.

Meanwhile, as an interest in an environmental regulation has recently grown worldwide, the regulation has been strengthened on usage of a substance that pollutes a global environment.

The refrigerant used in the air conditioning system may contain per-and polyfluoroalkyl substances (PFAS), and the PFAS may be used in almost all industries because the PFAS may maintain their original molecular structure without reacting with water, oil, chemicals, heat, or the like, and exhibit excellence in waterproofing, oil resistance, chemical resistance, and heat resistance. However, the PFAS may not be easily decomposed and thus be accumulated in a human body and the environment.

To solve the present problem, each country regulates the usage of the PFAS. For the present purpose, research is being conducted to replace the PFAS in the refrigerant used in the air conditioning system with an eco-friendly refrigerant.

The eco-friendly refrigerant may be eco-friendly due to its very low global warming potential (GWP), and have excellent cycle performance due to its large latent heat capacity. However, the eco-friendly refrigerant is classified as a very flammable substance, which requires safety design against flammability and explosion when using the eco-friendly refrigerant in the air conditioning system.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a centralized energy (CE) module configured for safely using an eco-friendly refrigerant having high flammability and high explosive property, and a vehicle including the same.

According to an exemplary embodiment of the present disclosure, provided is a centralized energy (CE) module including: a compressor mounted on a base plate of the CE module and compressing a refrigerant; a condenser mounted on the base plate to be spaced apart from the compressor, and condensing the compressed refrigerant supplied from the compressor connected to the condenser; a receiver dryer connected to the condenser and storing the liquid refrigerant; an evaporator mounted on the base plate to be spaced apart from the condenser, and evaporating the refrigerant supplied from an expansion valve connected to the evaporator and the compressor; a cover housing mounted on the base plate to accommodate the compressor, the condenser, the receiver dryer, the expansion valve, and the evaporator in the cover housing; and a fire extinguisher disposed on an outside of the cover housing, and including a fire extinguishing tank storing an extinguishing powder, a fire extinguishing passage connecting the fire extinguishing tank with an interior of the cover housing, and a fire extinguishing valve selectively opening the fire extinguishing passage.

The fire extinguishing tank may be disposed on an upper surface of the cover housing.

The fire extinguishing passage may include a first fire extinguishing passage extending from the fire extinguishing tank to one upper side of the cover housing, and a second fire extinguishing passage extending from the fire extinguishing tank to the other upper side of the cover housing.

The fire extinguishing tank may be disposed on a side surface of the cover housing.

The fire extinguishing passage may include a first fire extinguishing passage extending from the fire extinguishing tank to one upper side of the cover housing, and a second fire extinguishing passage extending from the fire extinguishing tank to the other upper side of the cover housing.

The refrigerant may be an R290 refrigerant.

According to an exemplary embodiment of the present disclosure, provided is a vehicle including: a cabin room where a passenger boards; and a centralized energy (CE) module cooling or heating the cabin room, wherein the CE module includes a compressor mounted on a base plate of the CE module and compressing a refrigerant, a condenser mounted on the base plate to be spaced apart from the compressor, and condensing the compressed refrigerant supplied from the compressor, a receiver dryer connected to the condenser and storing the liquid refrigerant, an evaporator mounted on the base plate to be spaced apart from the condenser, and evaporating the refrigerant supplied from an expansion valve connected to the evaporator and the compressor, a cover housing mounted on the base plate to accommodate the compressor, the condenser, the receiver dryer, the expansion valve, and the evaporator in the cover housing, and a fire extinguisher disposed on an outside of the cover housing, and including a fire extinguishing tank storing an extinguishing powder, a fire extinguishing passage connecting the fire extinguishing tank with an interior of the cover housing, and a fire extinguishing valve selectively opening the fire extinguishing passage.

The fire extinguishing tank may be disposed on an upper surface of the cover housing.

The fire extinguishing passage may include a first fire extinguishing passage extending from the fire extinguishing tank to one upper side of the cover housing, and a second fire extinguishing passage extending from the fire extinguishing tank to the other upper side of the cover housing.

The fire extinguishing tank may be disposed on a side surface of the cover housing.

The fire extinguishing passage may include a first fire extinguishing passage extending from the fire extinguishing tank to one upper side of the cover housing, and a second fire extinguishing passage extending from the fire extinguishing tank to the other upper side of the cover housing.

The CE module may be provided at the rear of the vehicle based on a driving direction of the vehicle.

The condenser and the receiver dryer of the CE module may be disposed at the rear of the cabin room to be adjacent to the cabin room.

A center of gravity of the fire extinguishing tank may be disposed between an extension line of a rear wheel and the cabin room.

The CE module may be provided at the front of the vehicle based on a driving direction of the vehicle.

The condenser and the receiver dryer of the CE module may be disposed at the front of the cabin room to be adjacent to the cabin room.

A center of gravity of the fire extinguishing tank may be disposed between an extension line of a front wheel and the cabin room.

The refrigerant may be an R290 refrigerant.

According to the embodiments, it is possible to prevent the fire caused by the eco-friendly refrigerant by spraying the extinguishing powder into the cover housing using the fire extinguisher provided in the CE module even if the refrigerant of the CE module leaks to the outside thereof.

Other effects capable of being obtained or predicted by the exemplary embodiments of the present disclosure are included directly or implicitly in the detailed description of the present disclosure. That is, the various effects expected according to an exemplary embodiment of the present disclosure are included in the detailed description described below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of a centralized energy (CE) module according to an exemplary embodiment of the present disclosure.

FIG. 2 is a perspective view of the CE module according to an exemplary embodiment of the present disclosure.

FIG. 3 and FIG. 4 are conceptual diagrams of the CE module according to an exemplary embodiment of the present disclosure.

FIG. 5 is a conceptual diagram of a CE module according to another exemplary embodiment of the present disclosure.

FIG. 6 is a conceptual diagram showing a configuration of a vehicle using the CE module according to an exemplary embodiment of the present disclosure.

FIG. 7 is a conceptual diagram showing a configuration of a vehicle using the CE module according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

A term used herein is only to describe specific embodiments, and is not intended to limit the present disclosure. As used herein, a term of a single number is intended to include its plural number unless the context clearly indicates otherwise. It should also be understood that the terms “include” and/or “including”, when used in the specification, specify the presence of the recited features, integers, steps, operations, elements and/or components, and do not exclude the presence or addition of one or more of other features, integers, steps, operations, elements, elements, components and/or groups thereof. As used herein, a term “and/or” includes any one or all combinations of the associated listed items.

Hereinafter, the exemplary embodiments of the present disclosure are described in detail with reference to the accompanying drawings for those skilled in the art to which the present disclosure pertains to easily practice the present disclosure. However, the present disclosure may be implemented in various different forms and is not limited to the exemplary embodiments provided herein.

A portion unrelated to the description is omitted to obviously describe the present disclosure, and the same or similar components are denoted by the same reference numeral throughout the specification.

Furthermore, the size and thickness of each component shown in the accompanying drawings are arbitrarily shown for convenience of explanation. Therefore, the present disclosure is not necessarily limited to contents shown in the accompanying drawings, and the thicknesses are exaggerated in the drawings to clearly represent several portions and regions.

Terms “module” and/or “unit” for components described in the following description are used only to make the specification easily understood. Therefore, these terms do not have meanings or roles distinguished from each other in themselves.

Furthermore, in describing the exemplary embodiments of the present disclosure, omitted is a detailed description of a case where it is decided that the detailed description of the known art related to the present disclosure may obscure the gist.

Furthermore, it should be understood that the accompanying drawings are provided only to allow the exemplary embodiments of the present disclosure to be easily understood, and the spirit of the present disclosure is not limited to the accompanying drawings and includes all the modifications, equivalents, and substitutions included in the spirit and scope of the present disclosure.

Terms including ordinal numbers such as “first” and “second” may be used to describe various components. However, these components are not limited to these terms.

A term of a singular number may be interpreted as the singular number or its plural number unless explicitly expressed such as “one”or “single”.

These terms are used only to distinguish one component and another component from each other.

Hereinafter, the description describes a centralized energy (CE) module according to an exemplary embodiment and the vehicle including the same in detail with reference to the accompanying drawings.

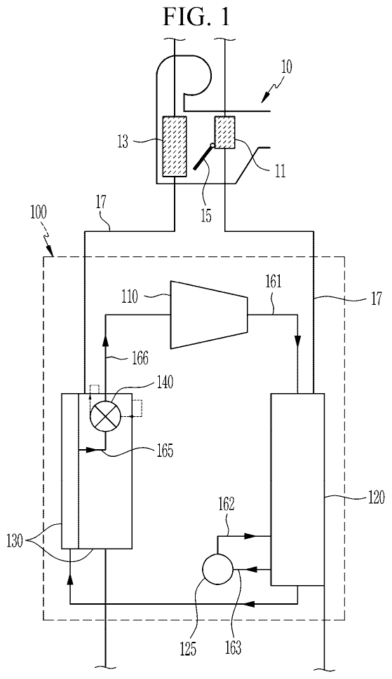

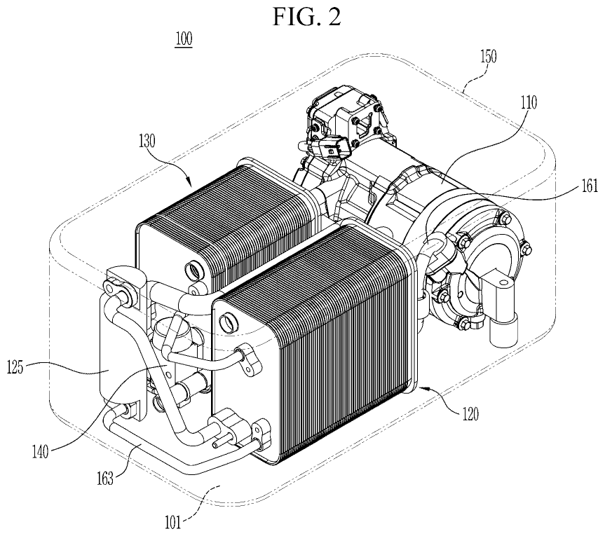

FIG. 1 is a perspective view of the CE module according to an exemplary embodiment of the present disclosure. Furthermore, FIG. 2 is a perspective view of the CE module according to an exemplary embodiment of the present disclosure.

As shown in FIG. 1 and FIG. 2, a heat pump system may use a CE module 100 according to an exemplary embodiment of the present disclosure. The CE module 100 may selectively exchange heat of a coolant with thermal energy generated in a refrigerant during condensation and evaporation of the refrigerant, and cool or heat a cabin room 350 of a vehicle 300 by use of only the low-temperature or high-temperature coolant.

An electric vehicle may include the heat pump system. The heat pump system may include the CE module 100 according to an exemplary embodiment of the present disclosure, together with a cooling unit, a battery module, and a heating, ventilation, and air conditioning (HVAC) module 10.

The cooling unit may cool an electrical component to prevent the component from overheating by circulating the coolant cooled by a radiator through an operation of a water pump.

The battery module may be connected to the cooling unit, and the coolant may be circulated therein through operation of the water pump, and power may be supplied to the electrical component.

The HVAC module 10 may include an internal heater 11, a cooler 13, and an opening or closing door 15.

The internal heater 11 and the cooler 13 may be connected to the CE module 100 through a coolant pipe 17. Furthermore, the opening or closing door 15 may be disposed between the internal heater 11 and the cooler 13. The opening or closing door 15 may be adjusted for external air passing through the cooler 13 to be selectively introducible to the internal heater 11, based on the cooling, heating, and heating/dehumidifying modes of the vehicle 300.

That is, in the heating mode of the vehicle 300, the opening or closing door 15 may be opened for the external air passing through the cooler 13 to be introduced to the internal heater 11. On the other hand, in the cooling mode of the vehicle 300, the opening or closing door 15 may close the internal heater 11 for the external air cooled by passing through the cooler 13 to be directly introduced to the interior of the vehicle 300.

Furthermore, the CE module 100 according to various exemplary embodiments of the present disclosure may selectively exchange heat of the coolant with the thermal energy generated during the condensation and evaporation of the refrigerant circulated in the module, and supply the heat-exchanged low-temperature or high-temperature coolant to the HVAC module 10, respectively.

Here, the refrigerant may be an eco-friendly R290 refrigerant. The R290 refrigerant may be eco-friendly because the refrigerant has a very low global warming potential (GWP) of 3. However, the R290 refrigerant has a very high flammability rating, i.e., high flammability and high explosiveness, which requires precautions.

When the heating mode of the vehicle 300 is operated, the high-temperature coolant may be supplied from the CE module 100 to the internal heater 11. On the other hand, when the cooling mode of the vehicle 300 is operated, the low-temperature coolant may be selectively supplied from the CE module 100 to the cooler 13.

In an exemplary embodiment of the present disclosure, the CE module 100 may include a base plate 101, a compressor 110, a condenser 120, an evaporator 130, an expansion valve 140, and a cover housing 150.

In an exemplary embodiment of the present disclosure, the base plate 101 may be formed in a square plate shape.

The compressor 110 may be mounted on the base plate 101. The compressor 110 may compress the gaseous refrigerant discharged from the evaporator 130 into a high-temperature and high-pressure gas. The compressor 110 may be connected to the condenser 120 through a first connection pipe 161.

The condenser 120 may be mounted on the base plate 101 to be spaced apart from the compressor 110. The condenser 120 may condense the compressed refrigerant supplied from the compressor 110 by exchanging heat with the coolant introduced thereto. Here, the condenser 120 may be connected to the coolant pipe 17 for the coolant to be introduced thereto and discharged therefrom, respectively, and each coolant pipe 17 may be connected to the HVAC module 10.

Meanwhile, the condenser 120 may be connected to a receiver dryer 125 storing the condensed refrigerant while passing through the interior thereof and removes moisture included in the refrigerant. The receiver dryer 125 may be separately disposed in the cover housing 150. The receiver dryer 125 may be formed in a shape of cylinder and may have a desiccant disposed therein.

The condenser 120 may be connected to a unit of the receiver dryer 125 through second and third connection pipes 162 and 163.

The condenser 120 may increase a coolant temperature by condensing the introduced refrigerant through the heat-exchange with the coolant, and supplying the coolant with the thermal energy generated during the condensation of the refrigerant. Therefore, the high-temperature coolant heat-exchanged while passing through the condenser 120 may be supplied to the internal heater of the HVAC module 10 to thus heat the cabin room 350 when the vehicle 300 is operated in the heating mode.

The condenser 120 may be formed as a water-cooled heat-exchanger in which the coolant is circulated.

Accordingly, the refrigerant supplied from the compressor 110 may be condensed through the heat-exchange with the coolant while passing through the condenser 120. The gaseous refrigerant, moisture, and a foreign substance may be removed while the refrigerant passes through the unit of the receiver dryer 125 through the second and third connection pipes 162 and 163.

The evaporator 130 may be mounted on the base plate 101 to be spaced apart from the condenser 120. The evaporator 130 may evaporate the refrigerant supplied from the expansion valve 140, which is integrally mounted thereon, through the heat-exchange with the coolant introduced thereto, and supply the evaporated refrigerant to the compressor 110. The evaporator 130 may be formed as the water-cooled heat-exchanger in which the coolant is circulated.

In an exemplary embodiment of the present disclosure, the expansion valve 140 may be integrally mounted on the evaporator 130. The expansion valve 140 may be a mechanical expansion valve or an electronic expansion valve.

The cover housing 150 may be mounted on the base plate 101 to accommodate the compressor 110, the condenser 120, the expansion valve 140, the receiver dryer 125, and the evaporator 130 therein.

The cover housing 150 may prevent the compressor 110, the condenser 120, the expansion valve 140, and the receiver dryer 125, the evaporator 130, and the expansion valve 140, mounted on the base plate 101, from being externally exposed thereof.

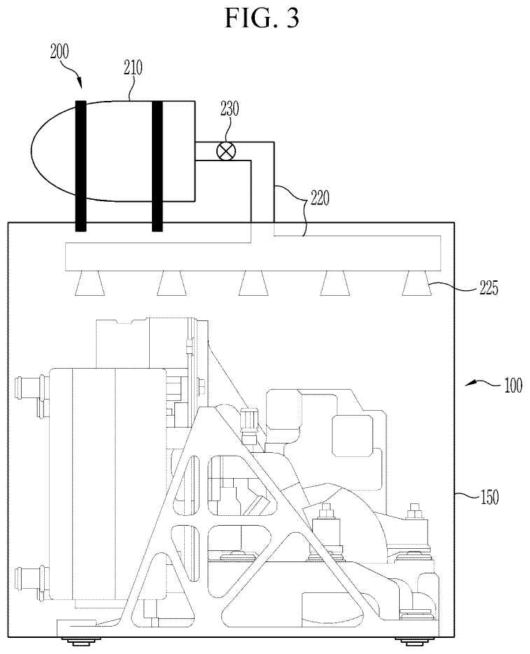

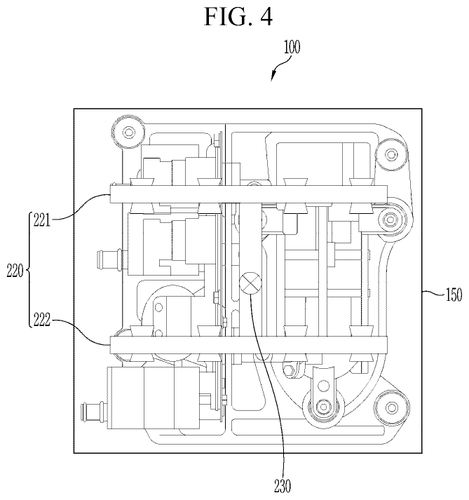

FIG. 3 and FIG. 4 are conceptual diagrams of the CE module according to an exemplary embodiment of the present disclosure.

As shown in FIG. 3 and FIG. 4, a fire extinguisher 200 may be disposed on the outside of the cover housing 150. The fire extinguisher 200 may include a fire extinguishing tank 210 storing an extinguishing powder, a fire extinguishing passage 220 connecting the fire extinguishing tank 210 with the interior of the cover housing 150, and a fire extinguishing valve 230 selectively opening the fire extinguishing passage 220.

The fire extinguishing tank 210 may store the extinguishing powder and be disposed on an upper surface of the cover housing 150.

The fire extinguishing passage 220 may fluidly connect the interior of the cover housing 150 to the fire extinguishing tank 210 for the extinguishing powder stored in the fire extinguishing tank 210 to be supplied to the interior of the cover housing 150.

If necessary, the plurality of fire extinguishing passages 220 may be provided. The plurality of fire extinguishing passages 220 may be provided to thus spray the extinguishing powder evenly to the interior of the cover housing 150.

For example, the fire extinguishing passage 220 may include a first fire extinguishing passage 221 extending from the fire extinguishing tank 210 to one upper side of the cover housing 150, and a second fire extinguishing passage 222 extending from the fire extinguishing tank 210 to the other upper side of the cover housing 150. A plurality of fire extinguishing nozzles 225 may be disposed on each of the first and second fire extinguishing passages 221 and 222.

The fire extinguishing valve 230 may be a one-way valve or a solenoid valve to selectively open the fire extinguishing passage 220. The fire extinguishing valve 230 may block the fire extinguishing passage 220 if the refrigerant does not leak to the interior of the cover housing 150. The fire extinguishing valve 230 may open the fire extinguishing passage 220 if the refrigerant leaks to the interior of the cover housing 150. Accordingly, the extinguishing powder may be sprayed from the fire extinguishing tank 210 to the interior of the cover housing 150 through the fire extinguishing passage 220.

For the present purpose, a refrigerant detection sensor configured for detecting whether the refrigerant leaks may be disposed in the cover housing 150.

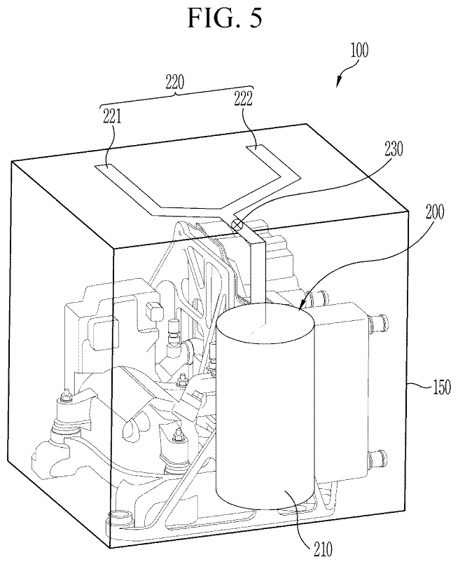

Referring to FIG. 5, the fire extinguishing tank 210 may be disposed on a side surface of the cover housing 150.

As shown in FIG. 3 and FIG. 4, the fire extinguishing passage 220 may fluidly connect the interior of the cover housing 150 to the fire extinguishing tank 210 for the extinguishing powder stored in the fire extinguishing tank 210 to be supplied to the interior of the cover housing 150.

If necessary, the plurality of fire extinguishing passages 220 may be provided. The plurality of fire extinguishing passages 220 may be provided to thus spray the extinguishing powder evenly to the interior of the cover housing 150.

For example, the fire extinguishing passage 220 may include the first fire extinguishing passage 221 extending from the fire extinguishing tank 210 to one upper side of the cover housing 150, and the second fire extinguishing passage 222 extending to the other upper side of the cover housing 150. As shown in FIG. 3, the plurality of fire extinguishing nozzles 225 may be disposed on each of the first and second fire extinguishing passages 221 and 222.

The fire extinguishing valve 230 may be the one-way valve or the solenoid valve to selectively open the fire extinguishing passage 220. The fire extinguishing valve 230 may block the fire extinguishing passage 220 if the refrigerant does not leak to the interior of the cover housing 150. The fire extinguishing valve 230 may open the fire extinguishing passage 220 if the refrigerant leaks to the interior of the cover housing 150. Accordingly, the extinguishing powder may be sprayed from the fire extinguishing tank 210 to the interior of the cover housing 150 through the fire extinguishing passage 220.

For the present purpose, the refrigerant detection sensor configured for detecting whether the refrigerant leaks may be disposed in the interior of the cover housing 150.

Next, the description describes a state where the vehicle is mounted with the CE module according to an exemplary embodiment in detail with reference to the accompanying drawings.

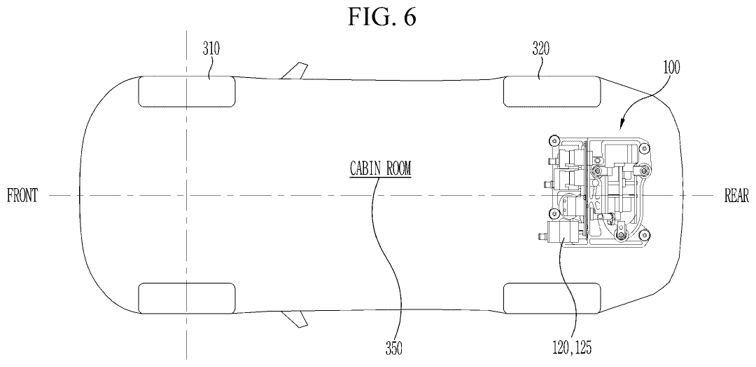

FIG. 6 is a conceptual diagram showing a configuration of the vehicle using the CE module according to an exemplary embodiment of the present disclosure.

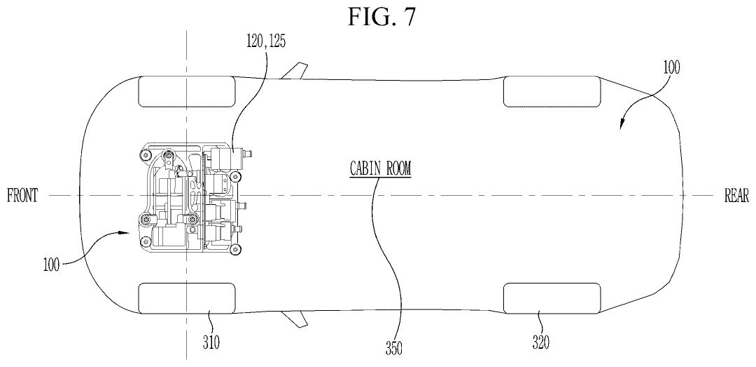

Furthermore, FIG. 7 is a conceptual diagram showing a configuration of the vehicle using the CE module according to another exemplary embodiment of the present disclosure.

Referring to FIG. 6, the CE module 100 according to various exemplary embodiments of the present disclosure may be provided in the vehicle 300. For example, the CE module 100 may be disposed at the rear of the cabin room 350 where a passenger including a driver boards.

In an exemplary embodiment of the present disclosure, a direction in which the vehicle 300 drives may be referred to as the front, and a direction opposite to the driving direction of the vehicle 300 may be referred to as the rear, based on the driving direction thereof.

If the CE module 100 is disposed at the rear of the cabin room 350, the condenser 120 and receiver dryer 125 of the CE module 100 may be disposed to face the cabin room 350. In other words, the condenser 120 and receiver dryer 125 of the CE module 100 may be disposed at the rear of the cabin room 350 to be adjacent to the cabin room 350.

In the present way, the condenser 120 and receiver dryer 125 of the CE module 100 may be disposed at the rear of the cabin room 350 to be adjacent to the cabin room 350, minimizing damage to the condenser 120 or the receiver dryer 125, which stores a large amount of the liquid refrigerant even if an accident such as a front-end collision occurs while the vehicle 300 drives.

That is, an impact caused by the collision may be absorbed by the cabin room 350 even if a front-end collision of the vehicle 300 occurs, minimizing the damage to the condenser 120 or the receiver dryer 125, which stores an eco-friendly refrigerant. In the present way, it is possible to secure safety of the CE module 100 using the eco-friendly refrigerant.

Furthermore, according to an exemplary embodiment of the present disclosure, the center of gravity of the fire extinguishing tank 210 may be disposed between an extension line of a rear wheel 320 and the cabin room 350. The extension line may a line connecting between a center of the rear wheels 350. In the present way, the center of gravity of the fire extinguishing tank 210 may be disposed between the extension line of the rear wheel 320 and the cabin room 350, minimizing damage to the fire extinguishing tank 210 even if the collision occurs while the vehicle 300 drives.

Referring to FIG. 7, the CE module 100 according to various exemplary embodiments of the present disclosure may be provided in the vehicle 300. For example, the CE module 100 may be disposed at the front of the cabin room 350 where the passenger including the driver boards.

If the CE module 100 is disposed at the front of the cabin room 350, the condenser 120 and receiver dryer 125 of the CE module 100 may be disposed to face the cabin room 350. In other words, the condenser 120 and receiver dryer 125 of the CE module 100 may be disposed at the front of the cabin room 350 to be adjacent to the cabin room 350.

In the present way, the condenser 120 and receiver dryer 125 of the CE module 100 may be disposed at the front of the cabin room 350 to be adjacent to the cabin room 350, minimizing the damage to the condenser 120 or the receiver dryer 125, which stores a large amount of the liquid refrigerant even if an accident such as a front-end collision occurs while the vehicle 300 drives.

That is, an impact caused by the collision may be absorbed by the cabin room 350 even if the front-end collision of the vehicle 300 occurs, minimizing the damage to the condenser 120 or the receiver dryer 125, which stores the eco-friendly refrigerant. In the present way, it is possible to secure the safety of the CE module 100 using the eco-friendly refrigerant.

Furthermore, according to an exemplary embodiment of the present disclosure, the center of gravity of the fire extinguishing tank 210 may be disposed between an extension line of a front wheel 310 and the cabin room 350. The extension line may a line connecting between a center of the front wheels 310. In the present way, the center of gravity of the fire extinguishing tank 210 may be disposed between the extension line of the front wheel 310 and the cabin room 350, minimizing the damage to the fire extinguishing tank 210 even if the collision occurs while the vehicle 300 drives.

The air conditioning system according to an exemplary embodiment and the vehicle 300 including the same may secure safety of the vehicle 300 provided with the CE module 100 using the eco-friendly refrigerant because the component such as the condenser 120 or the receiver dryer 125, which stores a large amount of the liquid refrigerant, are built in the cover housing 150 even if the CE module 100 utilizes the eco-friendly refrigerant such as the R290 refrigerant including the high flammability and high explosiveness.

Furthermore, even if the refrigerant of the CE module 100 leaks to the outside thereof, the fire extinguisher 200 provided in the CE module 100 may prevent a fire caused by the refrigerant, which is eco-friendly but highly flammable and explosive, by spraying the extinguishing powder to the interior of the cover housing 150.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A centralized energy (CE) module comprising:
a compressor mounted on a base plate of the CE module and compressing a refrigerant;
a condenser mounted on the base plate to be spaced apart from the compressor, and condensing the compressed refrigerant supplied from the compressor connected to the condenser;
a receiver dryer connected to the condenser and storing a liquid refrigerant;
an evaporator mounted on the base plate to be spaced apart from the condenser, and evaporating the refrigerant supplied from an expansion valve connected to the evaporator and the compressor;
a cover housing mounted on the base plate to accommodate the compressor, the condenser, the receiver dryer, the expansion valve, and the evaporator in the cover housing; and
a fire extinguisher disposed on an outside of the cover housing, and including a fire extinguishing tank storing an extinguishing powder, a fire extinguishing passage connecting the fire extinguishing tank with an interior of the cover housing, and a fire extinguishing valve selectively opening the fire extinguishing passage.

2. The module of claim 1, wherein the fire extinguishing tank is disposed on an upper surface of the cover housing.

3. The module of claim 2, wherein the fire extinguishing passage includes:
a first fire extinguishing passage extending from the fire extinguishing tank to a first upper side of the cover housing, and
a second fire extinguishing passage extending from the fire extinguishing tank to a second upper side of the cover housing.

4. The module of claim 1, wherein the fire extinguishing tank is disposed on a side surface of the cover housing.

5. The module of claim 4, wherein the fire extinguishing passage includes:
a first fire extinguishing passage extending from the fire extinguishing tank to a first upper side of the cover housing, and
a second fire extinguishing passage extending from the fire extinguishing tank to a second upper side of the cover housing.

6. The module of claim 1, wherein the refrigerant is an R290 refrigerant.

7. A vehicle comprising:
a cabin room where a passenger boards; and
a centralized energy (CE) module cooling or heating the cabin room,
wherein the CE module includes:
a compressor mounted on a base plate of the CE module and compressing a refrigerant,
a condenser mounted on the base plate to be spaced apart from the compressor, and condensing the compressed refrigerant supplied from the compressor connected to the condenser,
a receiver dryer connected to the condenser and storing a liquid refrigerant,
an evaporator mounted on the base plate to be spaced apart from the condenser, and evaporating the refrigerant supplied from an expansion valve connected to the evaporator and the compressor,
a cover housing mounted on the base plate to accommodate the compressor, the condenser, the receiver dryer, the expansion valve, and the evaporator in the cover housing, and
a fire extinguisher disposed on an outside of the cover housing, and including a fire extinguishing tank storing an extinguishing powder, a fire extinguishing passage connecting the fire extinguishing tank with an interior of the cover housing, and a fire extinguishing valve selectively opening the fire extinguishing passage.

8. The vehicle of claim 7, wherein the fire extinguishing tank is disposed on an upper surface of the cover housing.

9. The vehicle of claim 8, wherein the fire extinguishing passage includes:
a first fire extinguishing passage extending from the fire extinguishing tank to a first upper side of the cover housing, and
a second fire extinguishing passage extending from the fire extinguishing tank to a second upper side of the cover housing.

10. The vehicle of claim 7, wherein the fire extinguishing tank is disposed on a side surface of the cover housing.

11. The vehicle of claim 10, wherein the fire extinguishing passage includes:
a first fire extinguishing passage extending from the fire extinguishing tank to a first upper side of the cover housing, and
a second fire extinguishing passage extending from the fire extinguishing tank to a second upper side of the cover housing.

12. The vehicle of claim 7, wherein the CE module is provided at a rear of the vehicle based on a driving direction of the vehicle.

13. The vehicle of claim 12, wherein the condenser and the receiver dryer of the CE module are disposed at a rear of the cabin room to be adjacent to the cabin room.

14. The vehicle of claim 12, wherein a center of gravity of the fire extinguishing tank is disposed between an extension line of a rear wheel of the vehicle and the cabin room.

15. The vehicle of claim 7, wherein the CE module is provided at a front of the vehicle based on a driving direction of the vehicle.

16. The vehicle of claim 15, wherein the condenser and the receiver dryer of the CE module are disposed at a front of the cabin room to be adjacent to the cabin room.

17. The vehicle of claim 15, wherein a center of gravity of the fire extinguishing tank is disposed between an extension line of a front wheel of the vehicle and the cabin room.

18. The vehicle of claim 7, wherein the refrigerant is an R290 refrigerant.
